(19) United States
(12) Patent Application Publication
(10) Pub. No.: US 2010/0079887 A1
(43) Pub. Date: Apr. 1, 2010

(54) MAGNETIC TRANSFER METHOD AND MAGNETIC RECORDING MEDIUM

(75) Inventors: Tomokazu UMEZAWA, Kanagawa (JP); Yoichi NISHIDA, Kanagawa (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/570,198

(22) Filed: Sep. 30, 2009

(30) Foreign Application Priority Data
Sep. 30, 2008 (JP) JP 2008-254628

(51) Int. Cl. G11B 5/86

(52) U.S. Cl. 360/17; G9B/5.309

(57) ABSTRACT

To provide a magnetic transfer method including: initially magnetizing a perpendicular magnetic recording medium in a perpendicular direction; closely attaching a magnetic transfer master carrier to the initially magnetized perpendicular magnetic recording medium; transferring magnetic information to the perpendicular magnetic recording medium by applying a perpendicular magnetic field which acts in the opposite direction to the direction of the initial magnetization, with the perpendicular magnetic recording medium and the magnetic transfer master carrier closely attached to each other; and separating the magnetic transfer master carrier, which is closely attached to the perpendicular magnetic recording medium, from the perpendicular magnetic recording medium, wherein in the separating, the magnetic transfer master carrier is separated from the perpendicular magnetic recording medium while applying another perpendicular magnetic field which acts in the opposite direction to the direction of the initial magnetization.

### BACKGROUND OF THE INVENTION

1. Field of the Invention

The present invention relates to a magnetic transfer method in which magnetic information is transferred to a perpendicular magnetic recording medium, and a magnetic recording medium to which magnetic information has been transferred by the magnetic transfer method.

2. Description of the Related Art

As magnetic recording media capable of recording information in a highly dense manner, perpendicular magnetic recording media are well known. An information recording area of a perpendicular magnetic recording medium is composed of narrow tracks. Thus, a tracking servo technique for accurate scanning with a magnetic head within a narrow track width and for reproducing a signal with a high S/N ratio is important for the perpendicular magnetic recording medium. To perform this tracking servo, it is necessary to record servo information, for example a servo signal for tracking, an address information signal, a reproduction clock signal, etc. as a so-called preformat at predetermined intervals on the perpendicular magnetic recording medium.

As a method for preformatting servo information on a perpendicular magnetic recording medium, there is, for example, a method wherein while a master carrier with a pattern including a magnetic layer, which corresponds to the servo information, is closely attached to the perpendicular magnetic recording medium, a recording magnetic field (external magnetic field) is applied to the magnetic recording medium and the master carrier so as to magnetically transfer the pattern of the master carrier to the perpendicular magnetic recording medium (refer to Japanese Patent Application Laid-Open (JP-A) Nos. 2003-203325 and 2000-195048 and U.S. Pat. No. 7,218,465B1, for example).

In this method, when an external magnetic field is applied to a perpendicular magnetic recording medium 100 and a master carrier 110 with these closely attached to each other as shown in FIG. 13, a magnetic flux is absorbed into a magnetic layer 111 on a pattern based upon the magnetized state of the master carrier 110, and the magnetic field is strengthened correspondingly to the concavo-convex shape of the magnetic layer 111. By this magnetic field strengthened in the form of the pattern, only predetermined places on the perpendicular magnetic recording medium 100 are magnetized. Accordingly, magnetic materials with high saturation magnetization have hitherto been frequently used as materials for master magnetic layers (magnetic layers of master carriers).

Parenthetically, the magnetic layer of the master carrier is roughly several tens of nanometers in thickness and is therefore very thin. For that reason, once a transfer magnetic field is applied, a strong demagnetizing field is generated in the magnetic layer. When the demagnetizing field becomes strong, an effective magnetic field applied to the magnetic layer decreases even if a magnetic material with high saturation magnetization is used, and thus the concavo-convex magnetic layer comes into an unsaturated state. Hitherto, attempts have been made to bring the magnetic layer into a near-saturated state by further increasing an externally applied magnetic field to secure transfer magnetic field strength and increasing an effective magnetic field applied to the magnetic layer. However, since the magnetic layer magnetization increase rate related to the increasing of the applied magnetic field is in proportion to the strength of the applied magnetic field, the above-mentioned situation is, in effect, tantamount to a situation where a strong magnetic field is applied to a material with low saturation magnetization. The transfer magnetic field becomes strong on convex portions, causing the perpendicular magnetic recording medium to be magnetized in an almost saturated manner; however, the transfer magnetic field becomes strong on concave portions as well, Thus, the difference in transfer magnetic field strength between the convex portions and the concave portions is small. When servo information is transferred to the magnetic recording medium, with the difference in transfer magnetic field strength between the convex portions and the concave portions being small, a reversal of magnetization arises at places (concave portions) that should not be magnetized, so that the recording signal quality degrades, which is a problem.

In order to reduce the occurrence of the problem, the master carrier's magnetic layer itself needs to be magnetized in a saturated manner at a desired transfer magnetic field strength at least when the transfer magnetic field is applied, thereby enabling the magnetization value to be large.

When the magnetization value of the master carrier's magnetic layer itself can be sufficiently increased by a transfer magnetic field having a minimum strength required to magnetize the magnetic recording medium, the difference in transfer magnetic field strength between the convex portions and the concave portions can be increased, which is particularly favorable.

Under such circumstances, as the material of the magnetic layer, use of a material having magnetic anisotropy which acts in a direction perpendicular to the surface of the magnetic layer is being examined. It is thought that if such a material having perpendicular magnetic anisotropy is used for the magnetic layer of the master carrier, it is possible to minimize the strength of a transfer magnetic field applied as well as to easily increase the magnetization value of the magnetic layer by the transfer magnetic field.

However, even when a material having perpendicular magnetic anisotropy is selected as the material constituting the magnetic layer of the master carrier, the following problem arises. When the external magnetic field has finished being applied and the master carrier 110 is separated from the perpendicular magnetic recording medium 100, the magnetic layer 111 of the master carrier 110 in a state where there is remanent magnetization has a multidomain structure (see FIG. 14), and the direction of magnetization varies from portion to portion (see FIG. 15). Thus, when the master carrier 110 is separated from the perpendicular magnetic recording medium 100 after the completion of magnetic transfer, the magnetic field present at the magnetic layer 111 in the state where there is remanent magnetization is transferred to the magnetic recording medium 100 in a partial manner, which has an adverse effect on the quality of a transfer signal formed on the magnetic recording medium 100. Specifically, there is a problem of locally lost parts (parts indicated by the arrows in FIG. 16) in the waveform of a transfer signal at portions subjected to the magnetic transfer.

### BRIEF SUMMARY OF THE INVENTION

The present invention is aimed at solving the problems in related art and achieving the following object. An object of the present invention is to provide a magnetic transfer method capable of improving the quality of a transfer signal formed on a magnetic recording medium, and a magnetic recording medium to which magnetic information has been transferred by the magnetic transfer method.

Means for solving the problems are as follows.

<1> A magnetic transfer method including: initially magnetizing a perpendicular magnetic recording medium in a perpendicular direction; closely attaching a magnetic transfer master carrier to the initially magnetized perpendicular magnetic recording medium; transferring magnetic information to the perpendicular magnetic recording medium by applying a perpendicular magnetic field which acts in the opposite direction to the direction of the initial magnetization, with the perpendicular magnetic recording medium and the magnetic transfer master carrier closely attached to each other; and separating the magnetic transfer master carrier, which is closely attached to the perpendicular magnetic recording medium, from the perpendicular magnetic recording medium, wherein in the separating, the magnetic transfer master carrier is separated from the perpendicular magnetic recording medium while applying another perpendicular magnetic field which acts in the opposite direction to the direction of the initial magnetization.

Regarding the magnetic transfer method according to <1>, in the initially magnetizing, the perpendicular magnetic recording medium is initially magnetized in a perpendicular direction; in the closely attaching, the magnetic transfer master carrier is closely attached to the initially magnetized perpendicular magnetic recording medium; in the transferring, magnetic information is transferred to the perpendicular magnetic recording medium by applying a perpendicular magnetic field which acts in the opposite direction to the direction of the initial magnetization, with the perpendicular magnetic recording medium and the magnetic transfer master carrier closely attached to each other; and in the separating, the magnetic transfer master carrier, which is closely attached to the perpendicular magnetic recording medium, is separated from the perpendicular magnetic recording medium while applying another perpendicular magnetic field which acts in the opposite direction to the direction of the initial magnetization. Consequently, magnetization in a magnetic layer of the magnetic transfer master carrier can be kept facing one direction, which makes it possible to prevent partial reversal of magnetization, and thus the quality of a transfer signal formed on the magnetic recording medium can be improved.

<2> The magnetic transfer method according to <1>, wherein the magnetic transfer master carrier is provided with a magnetic layer, and the magnetic layer has perpendicular magnetic anisotropy.
<3> The magnetic transfer method according to one of <1> and <2>, wherein the strength of the another perpendicular magnetic field is less than 1.2 times the strength of a reversal magnetic field of the perpendicular magnetic recording medium.
<4> The magnetic transfer method according to one of <2> and <3>, wherein the strength of the another perpendicular magnetic field is greater than or equal to 0.02 times the strength of a saturation magnetic field of the magnetic layer.
<5> The magnetic transfer method according to <4>, wherein the strength of the another perpendicular magnetic field is greater than or equal to 0.10 times the strength of the saturation magnetic field of the magnetic layer.
<6> The magnetic transfer method according to <5>, wherein the strength of the another perpendicular magnetic field is greater than or equal to 0.15 times the strength of the saturation magnetic field of the magnetic layer.
<7> A magnetic recording medium to which magnetic information has been transferred by the magnetic transfer method according to any one of <1> to <6>.

According to the present invention, it is possible to solve the problems in related art and achieve the object of providing a magnetic transfer method capable of improving the quality of a transfer signal formed on a magnetic recording medium, and a magnetic recording medium to which magnetic information has been transferred by the magnetic transfer method.

### BRIEF DESCRIPTION OF THE DRAWINGS

FIG. 1A is a drawing for explaining a step in a perpendicular magnetic recording transfer method (Part 1).

FIG. 1B is a drawing for explaining a step in the perpendicular magnetic recording transfer method (Part 2).

FIG. 10 is a drawing for explaining a step in the perpendicular magnetic recording transfer method (Part 3).

FIG. 2 is a drawing for explaining the magnetization direction of a magnetic layer (recording layer) after an initially magnetizing step.

FIG. 3 is a drawing for explaining a cross section of a slave disk.

FIG. 4A is a partially cross-sectional view showing a master disk according to an embodiment (Part 1).

FIG. 4B is a partially cross-sectional view showing a master disk according to another embodiment (Part 2).

FIG. 5A is a drawing for explaining a method for producing a master disk, according to an embodiment (Part 1).

FIG. 5B is a drawing for explaining the method for producing a master disk, according to the embodiment (Part 2).

FIG. 5C is a drawing for explaining the method for producing a master disk, according to the embodiment (Part 3).

FIG. 5D is a drawing for explaining the method for producing a master disk, according to the embodiment (Part 4).

FIG. 5E is a drawing for explaining the method for producing a master disk, according to the embodiment (Part 5).

FIG. 6F is a drawing for explaining the method for producing a master disk, according to the embodiment (Part 6).

FIG. 6G is a drawing for explaining the method for producing a master disk, according to the embodiment (Part 7).

FIG. 6H is a drawing for explaining the method for producing a master disk, according to the embodiment (Part 8).

FIG. 6I is a drawing for explaining the method for producing a master disk, according to the embodiment (Part 9).

FIG. 6J is a drawing for explaining the method for producing a master disk, according to the embodiment (Part 10).

FIG. 7 is a top view of a master disk.

FIG. 8 is a drawing for explaining a magnetic transfer step.

FIG. 9 is a schematic structural drawing of a magnetic transfer apparatus used in the magnetic transfer step.

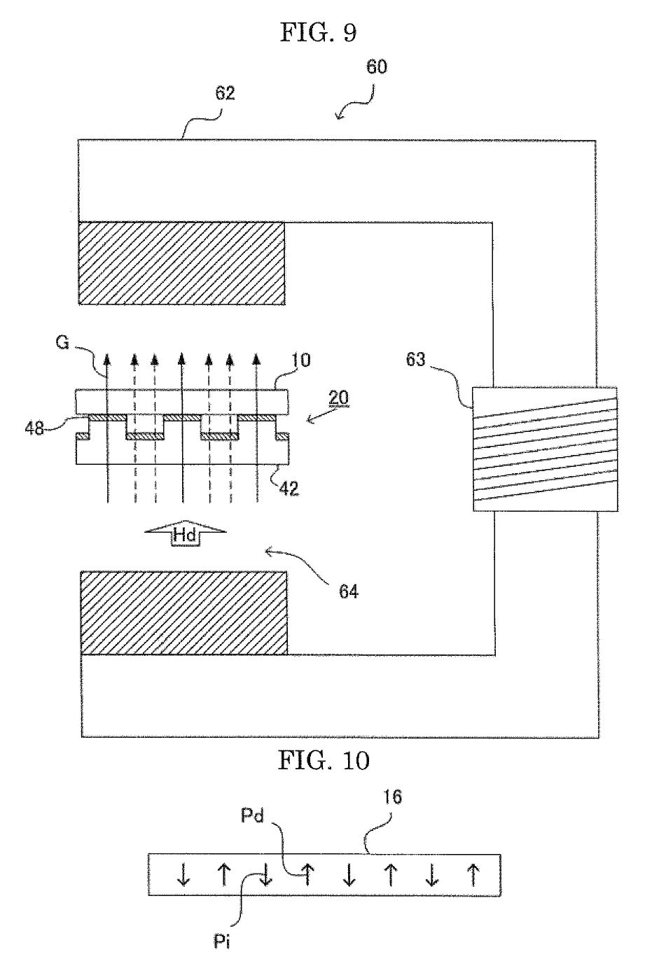

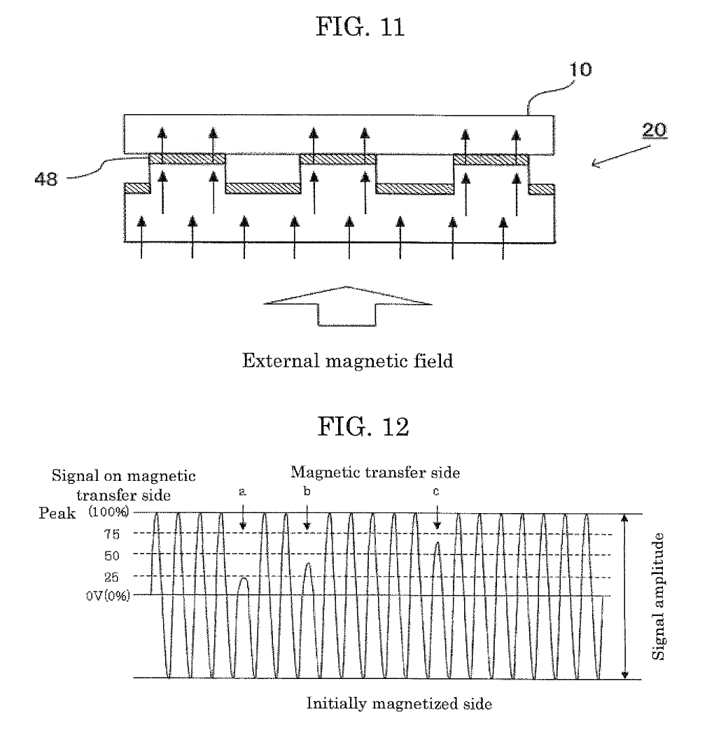

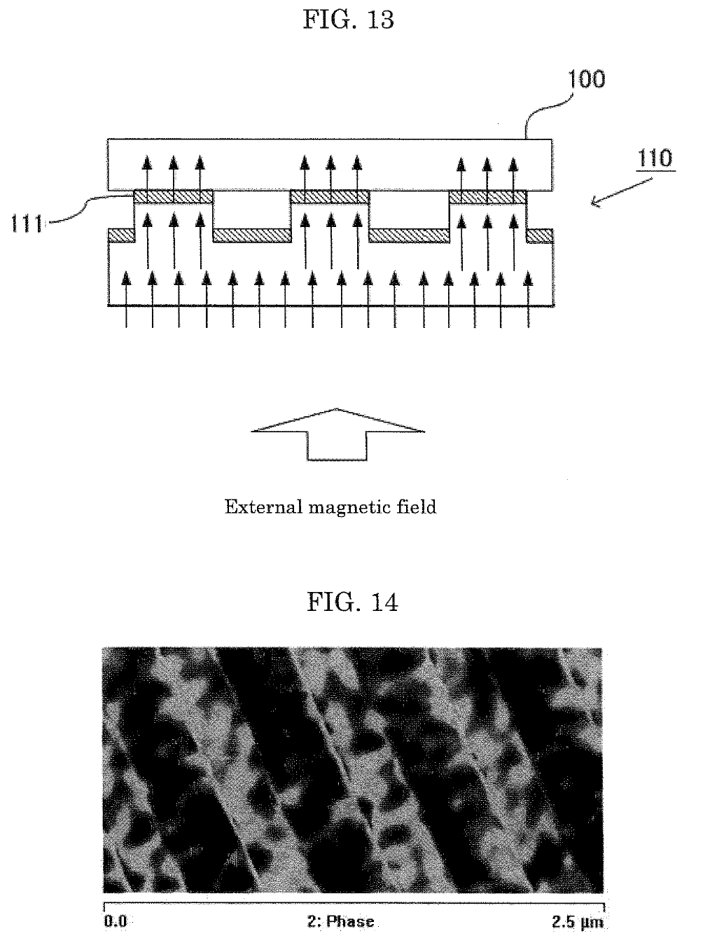

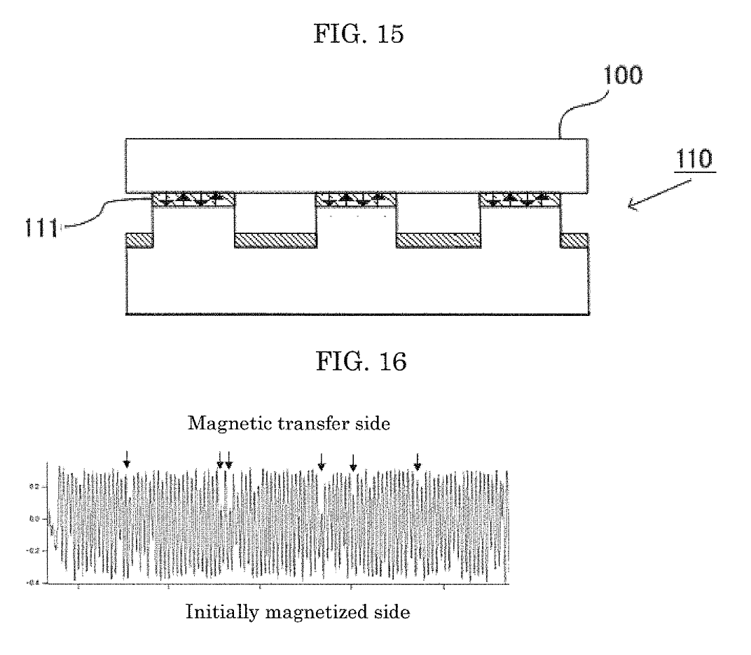

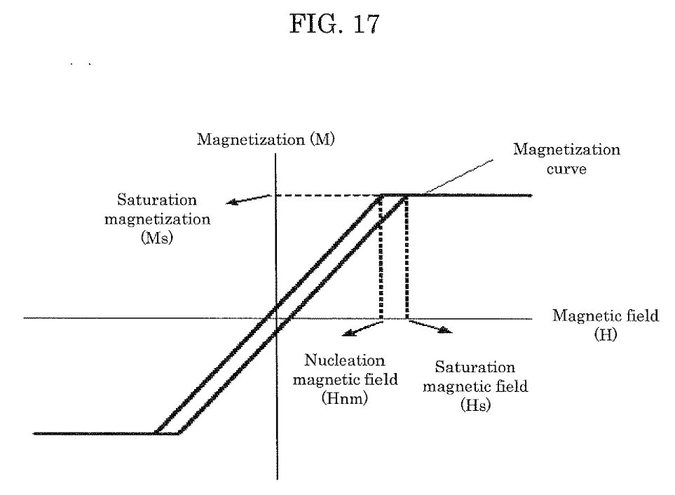

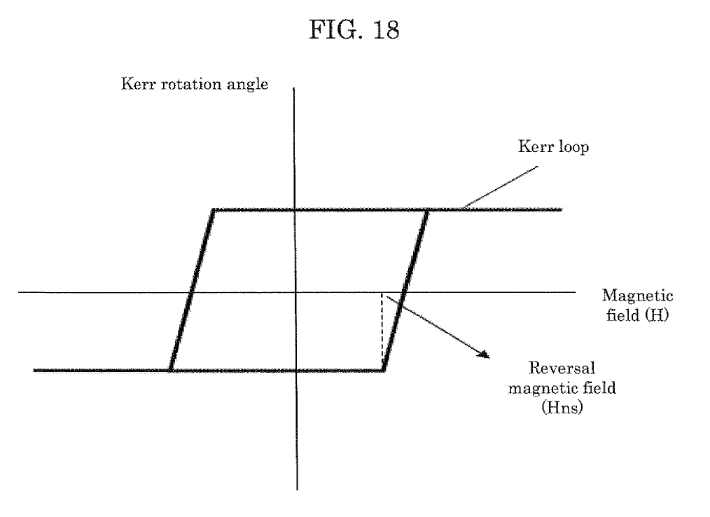

FIG. 10 is a drawing for explaining the magnetization direction of the magnetic layer (recording layer) after the magnetic transfer step.

FIG. 11 is a drawing for explaining a separating step.

FIG. 12 is a graph showing an example of the waveform of a transfer signal formed on a magnetic recording medium by a magnetic transfer method of the present invention.

FIG. 13 is a drawing for explaining a magnetic transfer step in a conventional magnetic transfer method.

FIG. 14 is a photograph showing a state of a master disk where there is remanent magnetization, after transfer of magnetic information by a conventional magnetic transfer method.

FIG. 15 is a drawing showing a state of a master disk where there is remanent magnetization, after transfer of magnetic information by a conventional magnetic transfer method.

FIG. 16 is a graph showing an example of the waveform of a transfer signal formed on a magnetic recording medium by a conventional magnetic transfer method.

FIG. 17 is a schematic diagram showing a magnetization curve regarding a master carrier.

FIG. 18 is a schematic diagram showing a Kerr loop regarding a perpendicular magnetic recording medium.

### DETAILED DESCRIPTION OF THE INVENTION

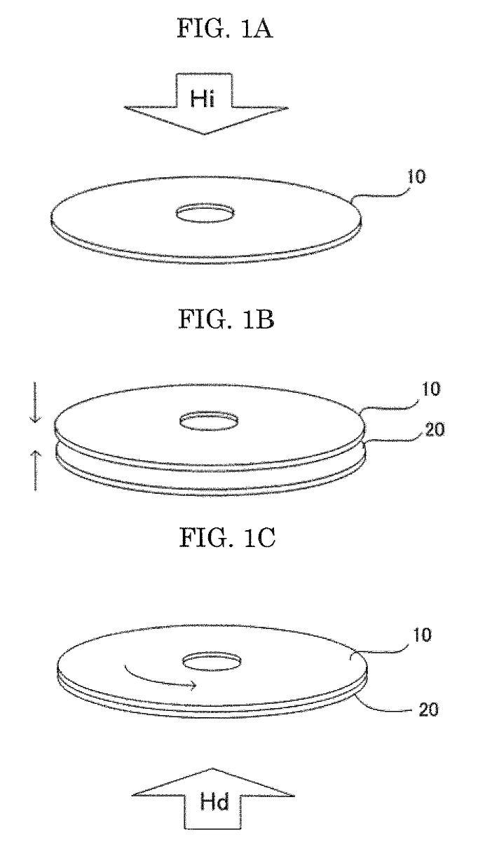

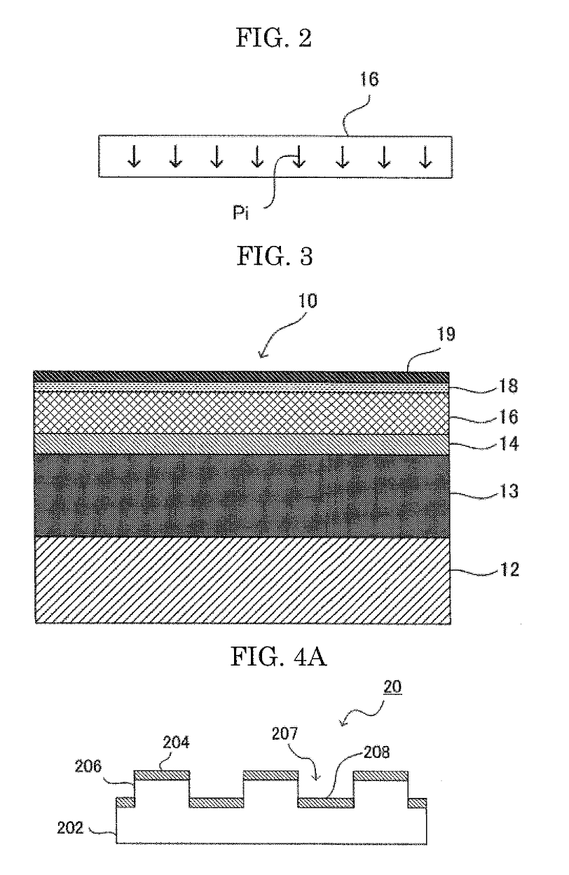

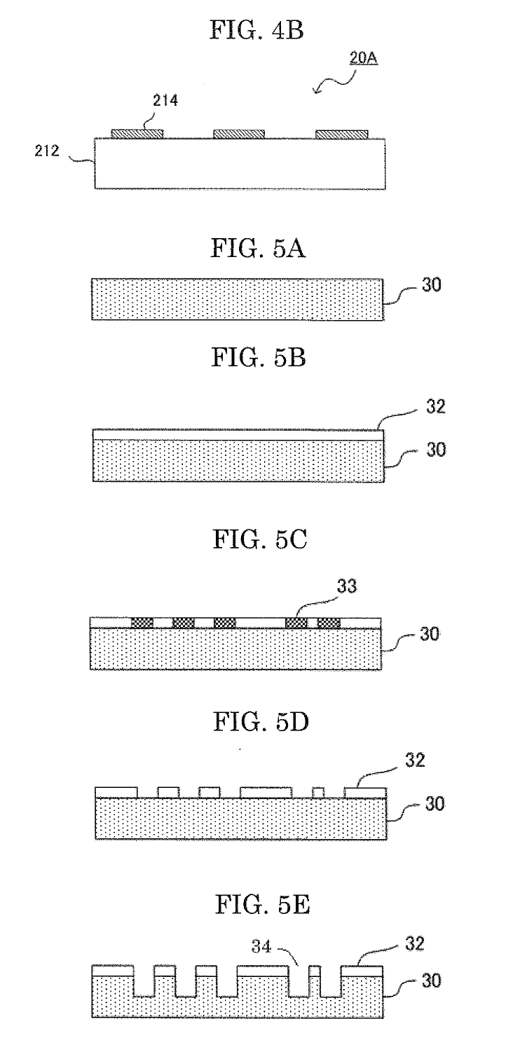

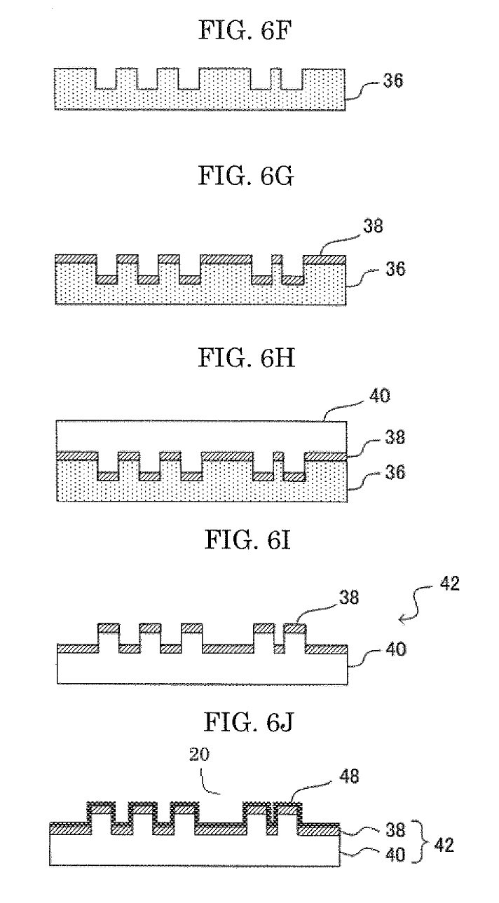

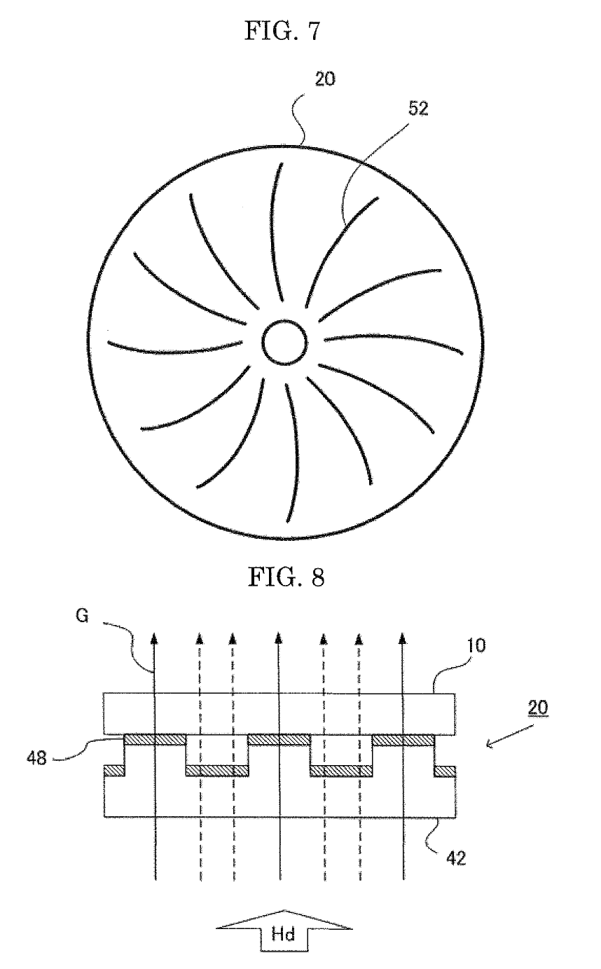

First of all, an outline of a magnetic transfer technique for perpendicular magnetic recording will be explained with reference to FIGS. 1A to 1C. FIGS. 1A to 1C are drawings for explaining respective steps in a magnetic transfer method for perpendicular magnetic recording. In FIGS. 1A to 1C, the numeral 10 denotes a slave disk (which is equivalent to a perpendicular magnetic recording medium) as a magnetic disk to which information is to be transferred, and the numeral 20 denotes a master disk as a magnetic transfer master carrier.

As shown in FIG. 1A, a DC magnetic field (Hi) is applied to a surface of the slave disk 10 from a perpendicular direction so as to initially magnetize the slave disk 10 (initially magnetizing step).

After the initially magnetizing step, the initially magnetized slave disk 10 and the master disk 20 are closely attached to each other as shown in FIG. 1B (closely attaching step).

After these disks 10 and 20 have been closely attached to each other, a magnetic field (Hd), which acts in the opposite direction to the direction of the magnetic field (Hi) applied at the time of the initial magnetization, is applied to the disks as shown in FIG. 1C, such that the information which the master disk 20 has is magnetically transferred to the slave disk 10 (magnetic transfer step).

### (Magnetic Transfer Method)

A magnetic transfer method of the present invention includes at least an initially magnetizing step, a closely attaching step, a magnetic transfer step and a separating step and, if necessary, includes other step(s).

### <Initially Magnetizing Step>

The initially magnetizing step is a step of initially magnetizing a perpendicular magnetic recording medium in a perpendicular direction.

Here, note that the perpendicular direction may involve an angular difference of within ±10°, preferably within ±5°, from the vertical direction to the surface of the perpendicular magnetic recording medium.

For instance, as shown in FIG. 1A, initial magnetization of the perpendicular magnetic recording medium (slave disk 10) is performed by generation of an initializing magnetic field Hi with the use of a device (magnetic field applying unit (not shown)) capable of applying a DC magnetic field perpendicularly to the surface of the slave disk 10. Specifically, it is performed by generating as the initializing magnetic field Hi a magnetic field which is greater than or equal to the coercive force He of the slave disk 10 in strength. By this initially magnetizing step, the magnetic layer 16 of the slave disk 10 is subjected to an initial magnetization Pi in one direction perpendicular to the disk surface, as shown in FIG. 2. It should be noted that this initially magnetizing step may be carried out by rotating the slave disk 10 relatively to the magnetic field applying unit.

### <Perpendicular Magnetic Recording Medium (Slave Disk)>

The slave disk 10 shown in FIGS. 1A to 1C includes a disc-shaped substrate, and magnetic layer(s) formed over one or both surfaces of the substrate. Specific examples thereof include high-density hard disks. The following explains a perpendicular magnetic recording medium with reference to FIG. 3, employing the slave disk 10 as an example.

FIG. 3 is a drawing for explaining a cross section of the slave disk 10. As shown in FIG. 3, the slave disk 10 includes a nonmagnetic substrate 12 made, for example, of glass and also includes a soft magnetic layer (soft magnetic underlying layer: SUL) 13, a nonmagnetic layer (intermediate layer) 14 and a magnetic layer (perpendicular magnetic recording layer) 16 formed over the substrate 12. Further, a protective layer 18 and a lubricant layer 19 are formed over the magnetic layer 16. Note that although an example in which the magnetic layer 16 is formed over one surface of the substrate 12 is herein shown, an aspect in which magnetic layers are formed over both surfaces of the substrate 12 is possible as well.

The disc-shaped substrate 12 is made of a nonmagnetic material such as glass or Al (aluminum). After the soft magnetic layer 13 is formed on the substrate 12, the nonmagnetic layer 14 and the magnetic layer 16 are formed.

The soft magnetic layer 13 is useful in that the perpendicularly magnetized state of the magnetic layer 16 can be stabilized and sensitivity at the times of recording and reproduction can be improved. The material used for the soft magnetic layer 13 is preferably selected from soft magnetic materials, for example CoZrNb, FeTaC, FeZrN, FeSi alloys, FeAl alloys, FeNi alloys such as permalloy, and FeCo alloys such as permendur. This soft magnetic layer 13 is provided with magnetic anisotropy in radius directions (in a radial manner) from the center of the disk toward the outside.

The thickness of the soft magnetic layer 13 is preferably 20 nm to 2,000 nm, more preferably 40 nm to 400 nm.

The nonmagnetic layer 14 is provided in order to increase the magnetic anisotropy of the subsequently formed magnetic layer 16 in a perpendicular direction or for some other reason. As the material used for the nonmagnetic layer 14, Ti (titanium), Cr (chromium), CrTi, CoCr, CrTa, CrMo, NiAl, Ru (ruthenium), Pd (palladium), Ta, Pt or the like is preferable. The nonmagnetic layer 14 is formed by depositing the material by means of sputtering. The thickness of the nonmagnetic layer 14 is preferably 10 nm to 150 nm, more preferably 20 nm to 80 nm.

The magnetic layer 16 is formed of a perpendicular magnetization film (which is configured such that magnetization easy axes in a magnetic film are oriented primarily perpendicularly to the substrate), and information is to be recorded in this magnetic layer 16. The material used for the magnetic layer 16 is preferably selected from Co (cobalt), Co alloys (CoPtCr, CoCr, CoPtCrTa, CoPtCrNbTa, CoCrB, CoNi, etc.), Co alloy-SiO₂, Co alloy-TiO₂, Fe, Fe alloys (FeCo, FePt, FeCoNi, etc.) and the like. High in magnetic flux density, any of these materials can have perpendicular magnetic anisotropy by adjustment of a deposition condition and/or its composition. The magnetic layer 16 is formed by depositing the material by means of sputtering. The thickness of the magnetic layer 16 is preferably 10 nm to 500 nm, more preferably 20 nm to 200 nm.

In the present embodiment, a disc-shaped glass substrate having an outer diameter of 65 mm is used as the substrate 12 of the slave disk 10, the glass substrate is set in a chamber of a sputtering apparatus, and the pressure is reduced to 1.33×10⁻⁵ Pa (1.0×10⁻⁷ Torr) thereafter, Ar (argon) gas is introduced into the chamber, and a first SUL having a thickness of 80 nm is deposited by sputtering with the use of a CoZrNb target provided in the chamber, the temperature of the substrate also in the chamber being set at room temperature. Subsequently, a Ru layer having a thickness of 0.8 nm is deposited on the first SUL by sputtering with the use of a Ru target provided in the chamber. Further, a second SUL having a thickness of 80 nm is deposited on the Ru layer by sputtering with the use of a CoZrNb target. With a magnetic field of 50 Oe or higher being applied in radius directions, the temperature of the SULs thus deposited by sputtering is raised to 200° C. and then cooled to room temperature.

Next, sputtering deposition is carried out by means of electric discharge under such a condition that the substrate temperature is made equal to room temperature, with the use of a Ru target. In this manner, the nonmagnetic layer 14 formed of Ru is deposited so as to have a thickness of 60 nm.

Thereafter, in a similar manner, Ar gas is introduced, and sputtering deposition is carried out by means of electric discharge under such a condition that the substrate temperature is made equal to room temperature, with the use of a CoCrPt—SiO₂ target provided in the same chamber. In this manner, the magnetic layer 16 which is formed of CoCrPt—SiO₂ and has a granular structure is deposited so as to have a thickness of 25 nm.

By the above-mentioned process, the transfer magnetic disk (slave disk) 10, in which the soft magnetic layer, the nonmagnetic layer and the magnetic layer have been deposited over the glass substrate, is produced.

### <Closely Attaching Step>

The closely attaching step is a step of closely attaching a magnetic transfer master carrier to the initially magnetized perpendicular magnetic recording medium.

In the closely attaching step, as shown in FIG. 1B, for example, the surface of the master disk 20 on the side of the protrusion pattern (concavo-convex pattern) and the surface of the slave disk 10 on the side of the magnetic layer 16 are closely attached to each other with a predetermined pressing force.

Before closely attached to the master disk 20, the slave disk 10 is, if necessary, subjected to a cleaning process (burnishing or the like) in which minute protrusions or attached dust on its surface is removed using a glide head, a polisher, etc.

As to the closely attaching step, there is a case in which the master disk 20 is closely attached to only one surface of the slave disk 10 as shown in FIG. 1B, and there is another case in which master disks are closely attached to both surfaces of a transfer magnetic disk, where magnetic layers have been formed. The latter case is advantageous in that transfer to both the surfaces can be simultaneously performed.

### <<Magnetic Transfer Master Carrier (Master Disk)>>

FIG. 4A is a partially cross-sectional view showing the master disk (master carrier) 20. This master disk 20 includes a base material 202 and a magnetic layer 204 formed on the surface of the base material 202. The base material 202 is provided with convex portions 206 and concave portions 207 on its surface. The convex portions 206 are provided with the magnetic layer 204 on their surfaces. Additionally, in the present embodiment, a magnetic layer 208 is formed on the surfaces of the concave portions 207 for the sake of facilitation of production, etc. In other embodiments, however, the provision of the magnetic layer 208 in the concave portions 207 may be omitted.

The magnetic layer 204 formed at the surfaces (apical surfaces) of the convex portions 206 of the base material 202 serves as bit portions corresponding to a transfer signal. These bit portions are portions to reverse an initial magnetization, and are equivalent to transfer portions. Meanwhile, the concave portions 207 are equivalent to non-transfer portions where a magnetization is not reversed.

FIG. 4B is a partially cross-sectional view showing a master disk 20A according to another embodiment. This master disk 20A includes a base material 212 and, on a surface of the base material 212, a magnetic layer 214 serving as bit portions corresponding to a transfer signal. As to this master disk 20A, the magnetic layer 214 is equivalent to transfer portions, and portions (gaps) between adjacent sections of the magnetic layer 214 are equivalent to non-transfer portions.

### <<<Base Material>>>

The base material is produced using a known material, for example glass, a synthetic resin such as polycarbonate, a metal such as nickel or aluminum, silicon or carbon.

### <<<Magnetic Layer>>>

The magnetic layer preferably, but not necessarily, has perpendicular magnetic anisotropy. The magnetic layer may be a non-oriented film or an in-plane magnetic anisotropy film as well.

Whether or not the magnetic layer has perpendicular magnetic anisotropy is judged by the following method.

### <<<Method for Evaluating Perpendicular Magnetic Anisotropy>>>

The presence of perpendicular magnetic anisotropy is defined as follows: the magnetic layer is judged to have perpendicular magnetic anisotropy, provided that the perpendicular magnetic anisotropy energy measured using a known magnetic torquemeter is 5×10⁵ erg/cm³ or greater.

FIG. 17 shows a magnetization curve regarding the magnetic layer of the master disk. The saturation magnetization (Ms) of the magnetic layer is preferably 500 emu/cc or above. When the saturation magnetization is less than 500 emu/cc, it is possible that even when the magnetic layer has perpendicular magnetic anisotropy and is magnetized in a saturated manner, a sufficient difference in transfer magnetic field strength between convex portions and concave portions may not be secured and thus adequate transfer properties may not be secured.

Also, the nucleation magnetic field (Hnm) of the magnetic layer is preferably a positive value (Hnm>0). When the nucleation magnetic field (Hnm) is 0 or less (Hnm≦0), a great magnetic field is generated from the magnetic layer even after removal of a transfer magnetic field subsequent to the finish of magnetic transfer, so that overwriting may arise, making it impossible to record a desired signal.

The nucleation magnetic field (Hnm) of the magnetic layer is preferably lower than or equal to the applied magnetic field (transfer magnetic field, Hd) in strength because the saturation magnetization (Ms) of the magnetic layer can be effectively utilized.

The saturation magnetization (emu/cc), the nucleation magnetic field (Hnm) and the saturation magnetic field (Hs) of the magnetic layer can be calculated using a known vibrating sample magnetometer. The saturation magnetization (emu/cc) can be calculated by measuring the saturation magnetic moment (emu) from a magnetization curve obtained using the vibrating sample magnetometer, and dividing the saturation magnetic moment by the volume (cc) of the magnetic layer. The nucleation magnetic field (Hnm) and the saturation magnetic field (Hs) can be calculated from the magnetization curve as shown in FIG. 17.

When the value of the coercive force (He) of the magnetic layer is too large, the magnetic layer is not magnetized by the magnetic field applied. Also, magnetic transfer may be impossible. When a transfer magnetic field with great strength is applied, the magnetic field in the concave portions is strengthened. Therefore, the coercive force (Hc) of the magnetic layer is preferably weaker than or equal to the coercive force of a corresponding perpendicular magnetic recording medium; specifically, it is preferably 6,000 Oe or less, more preferably 4,000 Oe or less.

The material used for the magnetic layer of the master disk (master carrier) is an alloy or compound composed of at least one ferromagnetic metal selected from Fe, Co and Ni and at least one nonmagnetic substance selected from Cr, Pt, Ru, Pd, Si, Ti, B, Ta and O. It is particularly desirable that the material be an alloy (CoPt) composed of Co and Pt.

A protective layer is formed over the surface of the master disk to improve the mechanical properties, friction resistance and weatherability of the master disk.

As the material for this protective layer, a hard carbon film is preferable, and inorganic carbon, diamond-like carbon, etc. formed by sputtering may be used. Further, a layer formed of a lubricant (a lubricant layer) may be formed over this hard protective layer.

A fluorine resin, e.g. perfluoropalyether (PFPE), is generally used as such a lubricant.

Magnetic transfer is performed a plurality of times, using the master disk over which the hard protective layer and the lubricant layer have been formed.

Parenthetically, since minute pinholes exist in the hard protective layer and the coverage of the lubricant layer is often low, it is possible that moisture may enter from the pinholes in the step of performing magnetic transfer a plurality of times and thus an oxide of a component of the magnetic layer may form over the surface of the master disk in the case where the master disk is a conventional master disk. Owing to the formation of the oxide, the volume of the magnetic layer increases, expanded portions of the magnetic layer have convex shapes and there is a physical defect in the surface of a slave disk in some cases.

Especially when a conventional master disk having a magnetic layer made of FeCo is brought into contact with a slave disk, there is such a problem that oxidation and corrosion of a metal element of the magnetic layer, particularly Fe, selectively arise.

In contrast, use of a master disk having a magnetic layer made of CoPt composed of Co and Pt, which are lower in ionization tendency than Fe, makes it possible to greatly reduce the adverse effects of the problem.

The magnetic layer of the master disk (master carrier) can be formed by sputtering, for example. In the case where the magnetic layer is formed of CoPt, its magnetic properties can be controlled primarily by adjusting the sputter pressure and the Pt concentration at the time of formation of the magnetic layer. Note that when the sputter pressure is set at lower than 0.2 Pa, electric discharge is generally difficult. The sputter pressure is preferably 0.2 Pa to 50 Pa, more preferably 0.2 Pa to 10 Pa. The Pt concentration is preferably 5 at. % to 30 at. %, more preferably 10 at. % to 25 at. %.

### <<<Underlying Layer>>>

In order to adjust the perpendicular orientation, magnetic anisotropy energy (Ku), saturation magnetization (Ms) and nucleation magnetic field (Hnm) of the magnetic layer of the master disk (master carrier), an underlying layer may be formed under the magnetic layer (between the magnetic layer and the base material).

The material for the underlying layer is, for example, a metal, alloy or compound that contains at least one selected from the group consisting of Pt, Ru, Pd, Co, Cr, Ni, W, Ta, Al, P, Si and Ti. The material for the underlying layer is preferably a platinum group metal such as Pt or Ru, or an alloy thereof. The underlying layer may have a single-layer structure or a multilayer structure.

The thickness of the underlying layer is preferably 1 nm to 30 nm, more preferably 5 nm to 20 nm. When the thickness of the underlying layer is greater than 30 nm, the shape of the magnetic layer formed on the pattern of the master disk may degrade, thereby possibly leading to degradation of the distribution of a transfer magnetic field and degradation of the quality of a recording signal. When the thickness of the underlying layer is less than 1 nm, perpendicular orientation of the magnetic layer may be impossible, or the magnetic anisotropy energy, saturation magnetization and nucleation magnetic field of the magnetic layer may not be able to be controlled.

The thickness of the underlying layer is preferably 20 nm or less. When the thickness is 20 nm or less, it is possible to reduce degradation of the shape of the pattern after the formation of the magnetic layer and greatly improve magnetic transfer properties.

### <<Method for Producing Master Disk>>

FIGS. 5A to 5E and FIGS. 6F to 6J are drawings for explaining a process of producing a master disk. A method for producing a master disk according to an embodiment will be explained with reference to FIGS. 5A to 5E and FIGS. 6F to 6J.

As shown in FIG. 5A, an original plate (Si substrate) 30, which is a silicon wafer whose surface is smooth, is prepared, an electron beam resist solution is applied onto this original plate 30 by spin coating or the like so as to form a resist layer 32 thereon (see FIG. 5B), and the resist layer 32 is baked (pre-baked).

Next, the original plate 30 is set on a high-precision rotary stage or X-Y stage provided in an electron beam exposure apparatus (not shown), an electron beam modulated correspondingly to a servo signal is applied while the original plate 30 is being rotated, and a predetermined pattern 33 is formed on the substantially entire surface of the resist layer 32; for example, a pattern that corresponds to a servo signal and that linearly extends in radius directions from the rotational center toward each track is formed at portions corresponding to frames on the circumference by writing exposure (electron beam writing) (see FIG. 5C).

Subsequently, as shown in FIG. 5D, the resist layer 32 is developed, the exposed (written) portions are removed, and a coating layer having a desired thickness is formed by the remaining resist layer 32. This coating layer serves as a mask in a subsequent step (etching step). Additionally, the resist applied onto the original plate 30 can be of positive type or negative type; it should be noted that an exposed (written) pattern formed when a positive-type resist is used is an inversion of an exposed (written) pattern formed when a negative-type resist is used. After this developing process, a baking process (post-baking) is carried out to enhance the adhesion between the resist layer 32 and the original plate 30. Subsequently, as shown in FIG. 5E, parts of the original plate 30 are removed (etched) at places where opening portions 34 of the resist layer 32 exist, such that hollows having a predetermined depth are formed in the original plate 30. As to this etching, anisotropic etching is desirable in that an undercut (side etching) can be minimized. Reactive ion etching (RIE) can be suitably employed as such anisotropic etching.

Thereafter, as shown in FIG. 6F, the resist layer 32 is removed. Regarding the method for removing the resist layer 32, ashing can be employed as a dry method, and a removal method using a release liquid can be employed as a wet method. By the ashing process, an original master 36 on which an inversion of a desired concavo-convex pattern is formed is produced.

Subsequently, as shown in FIG. 6G, a conductive layer 38 is formed on the surface of the original master 36 so as to have a uniform thickness. The method for forming this conductive layer 38 can be suitably selected from metal deposition methods and the like, including PVD (physical vapor deposition), CVD (chemical vapor deposition), sputtering and ion plating. Formation of one layer made of a conductive film (denoted by the numeral 38), as described above, makes it possible to obtain such an effect that a metal can be uniformly electrodeposited in a subsequent step (electroforming step). The conductive layer 38 is preferably a film composed mainly of Ni. Since such a film composed mainly of Ni can be easily formed and is hard, it is suitable as the conductive film. The thickness of the conductive layer 38 is not particularly limited; generally though, the thickness is several tens of nanometers or so.

Then, as shown in FIG. 6H, a metal plate 40 made of a metal (Ni in this case), which has a desired thickness, is laid over the surface of the original master 36 by electroforming (reversed plate forming step). This step is performed by immersing the original master 36 in an electrolytic solution placed in an electroforming device, utilizing the original master 36 as an anode, and passing an electric current between the anode and a cathode. The concentration of the electrolytic solution, the pH, the manner in which the electric current is applied, etc. are required to be adjusted under an optimized condition where the laid metal plate 40 (which is a master substrate equivalent to the base material 202 explained with FIG. 4A) does not warp.

The original master 36 over which the metal plate 40 has been laid as described above is taken out from the electrolytic solution in the electroforming device and then immersed in purified water placed in a release bath (not shown).

Subsequently, in the release bath, the metal plate 40 is separated from the original master 36 (separating step), and a master substrate 42 having a concavo-convex pattern which is an inversion of the concavo-convex pattern of the original master 36 is thus obtained as shown in FIG. 6I.

Subsequently, as shown in FIG. 6J, a magnetic layer 48 is formed on the concavo-convex surface of the master substrate 42. Examples of the material for the magnetic layer 48 include CoPt. The thickness of the magnetic layer 48 is preferably 10 nm to 320 nm, more preferably 20 nm to 300 nm, even more preferably 30 nm to 100 nm. The magnetic layer 48 is formed by sputtering, using a target made of the above-mentioned material.

Thereafter, the master substrate 42 is subjected to punching such that its inner and outer diameters have predetermined sizes. By the above-mentioned process, a master disk 20 having the concavo-convex pattern provided with the magnetic layer 48 (equivalent to the magnetic layer 204 in FIG. 4A) is produced as shown in FIG. 6J.

FIG. 7 is a top view of the master disk 20. As shown in FIG. 7, a servo pattern 52 that is a concavo-convex pattern is formed on the surface of the master disk 20. Also, although not shown therein, a protective film (protective layer) made, for example, of diamond-like carbon may be provided over the magnetic layer 48 (see FIG. 6J) on the surface of the master disk 20, and further, a lubricant layer may be provided over the protective film.

The purpose of the provision of the protective layer is to prevent a case in which when the master disk 20 is closely attached to the slave disk 10, the magnetic layer 48 easily gets scratched and the use of the master disk 20 is thus made impossible. The lubricant layer has an effect of preventing, for example, formation of scratches attributed to friction caused when the master disk 20 is brought into contact with the slave disk 10, and thusly improving the durability of the master disk 20.

Specifically, a preferred structure is as follows: a carbon film having a thickness of 2 nm to 30 nm is formed as a protective layer, and a lubricant layer is formed thereon. Also, in order to enhance the adhesion between the magnetic layer 48 and the protective layer, an adhesion enhancing layer of Si or the like may be formed on the magnetic layer 48 before forming the protective layer.

### <Magnetic Transfer Step>

The magnetic transfer step is a step of magnetically transferring magnetic information to the perpendicular magnetic recording medium by applying a perpendicular magnetic field which acts in the opposite direction to the direction of the initial magnetization, with the perpendicular magnetic recording medium and the magnetic transfer master carrier closely attached to each other.

Note that the opposite direction to the direction of the initial magnetization does not necessarily mean the completely opposite direction to the direction of the initial magnetization but may involve an angular difference of within ±15° from the completely opposite direction.

Here, the magnetic transfer step is explained with reference to FIG. 1C. To the slave disk 10 and the master disk 20 that have been closely attached to each other by the closely attaching step, a recording magnetic field Hd is generated in the opposite direction to the direction of the initializing magnetic field Hi by a magnetic field applying unit (not shown). Magnetic transfer is effected by entry of a magnetic flux, produced by generating the recording magnetic field Hd, into the slave disk 10 and the master disk 20.

In the present embodiment, the value of the recording magnetic field Hd is approximately equal to that of the coercive force He of the magnetic material constituting the magnetic layer 16 of the slave disk 10.

In the magnetic transfer, while the slave disk 10 and the master disk 20 closely attached to each other are being rotated by a rotating unit (not shown), the recording magnetic field Hd is applied by the magnetic field applying unit, and information in the form of the protrusion pattern, recorded on the master disk 20, is magnetically transferred to the magnetic layer 16 of the slave disk 10. Apart from this structure, a mechanism for rotating the magnetic field applying unit may be provided such that the magnetic field applying unit is rotated relatively to the slave disk 10 and the master disk 20.

FIG. 8 shows a cross section of the slave disk 10 and the master disk 20 in the magnetic transfer step. When the recording magnetic field Hd is applied with the slave disk 10 closely attached to the master disk 20 having the concavo-convex pattern as shown in FIG. 8, a magnetic flux G becomes strong in areas where the convex portions of the master disk 20 and the slave disk 10 are in contact with each other, the recording magnetic field Hd causes the magnetization direction of the magnetic layer 48 of the master disk 20 to align with the direction of the recording magnetic field Hd, and thus the magnetic information is transferred to the magnetic layer 16 of the slave disk 10. Meanwhile, at the concave portions of the master disk 20, the magnetic flux G generated by the application of the recording magnetic field Hd is weaker than at the convex portions, and the magnetization direction of portions of the magnetic layer 16 of the slave disk 10 which correspond to the concave portions does not change, so that the portions remain in the initially magnetized state.

FIG. 9 shows in a detailed manner a magnetic transfer apparatus used for magnetic transfer. The magnetic transfer apparatus includes a magnetic field applying unit 60 composed of an electromagnet which is formed by winding a coil 63 around a core 62. By applying an electric current to the coil 63, a magnetic field is generated in a gap 64 perpendicularly to the master disk 20 and the magnetic layer 16 of the slave disk 10 which are closely attached to each other. The direction of the magnetic field generated can be changed depending upon the direction of the electric current applied to the coil 63. Therefore, both initial magnetization of the slave disk 10 and magnetic transfer can be performed by this magnetic transfer apparatus.

In the case where magnetic transfer is carried out after initial magnetization is performed, using this magnetic transfer apparatus, an electric current which flows in the opposite direction to the direction of an electric current applied to the coil 63 of the magnetic field applying unit 60 at the time of the initial magnetization is applied to the coil 63. This makes it possible to generate a recording magnetic field in the opposite direction to the magnetization direction at the time of the initial magnetization. In the magnetic transfer, while the slave disk 10 and the master disk 20 closely attached to each other are being rotated, the recording magnetic field Hd is applied by the magnetic field applying unit 60, and the information in the form of the protrusion pattern, recorded on the master disk 20, is magnetically transferred to the magnetic layer 16 of the slave disk 10; accordingly, a rotating unit (not shown) is provided. Apart from this structure, a mechanism for rotating the magnetic field applying unit 60 may be provided such that the magnetic field applying unit 60 is rotated relatively to the slave disk 10 and the master disk 20.

In the present embodiment, magnetic transfer is effected by applying as the recording magnetic field Hd a magnetic field which is equivalent in strength to 40% to 130%, preferably 50% to 120%, of the coercive force He of the magnetic layer 16 of the slave disk 10 used in the present embodiment.

Thus, in the magnetic layer 16 of the slave disk 10, information in the form of a magnetic pattern, such as a servo signal, is recorded as a recording magnetization Pd which acts in the opposite direction to the direction of the initial magnetization Pi (see FIG. 10).

### <Separating Step>

The separating step is a step of separating the magnetic transfer master carrier, which is closely attached to the perpendicular magnetic recording medium, from the perpendicular magnetic recording medium while applying another perpendicular magnetic field which acts in the opposite direction to the direction of the initial magnetization.

For instance, as shown in FIG. 11, in the separating step, the master disk 20 closely attached to the slave disk 10 is separated from the slave disk 10 while applying another perpendicular magnetic field which acts in the opposite direction to the direction of the initial magnetization (which acts in the same direction as the direction of the perpendicular magnetic field applied in the magnetic transfer step). Thus, magnetization in the magnetic layer 48 of the master disk 20 is oriented in one direction, so that it is possible to remove adverse effects on the waveform of a signal at portions subjected to the magnetic transfer (waveform of a signal corresponding to the convex portions of the master carrier in the waveform of a transfer signal formed on the slave disk 10) when the magnetic transfer is complete.

The application of the magnetic field in the separating step is effective in controlling the remanent magnetization in the magnetic layer of the magnetic transfer master carrier, thereby making it possible to remove adverse effects on the waveform of a signal at portions subjected to the magnetic transfer (hereinafter, the term “on the magnetic transfer side” will be used to mean “at portions subjected to the magnetic transfer”) in the waveform of a transfer signal formed on the slave disk. The remanent magnetization in the magnetic layer of the master carrier can be very effectively controlled by the application of the magnetic field in the separating step, particularly when the magnetic layer is a perpendicular magnetization film. Besides, it can be effectively controlled when the magnetic layer is a non-oriented film or an in-plane magnetic anisotropy film.

Here, note that the opposite direction to the direction of the initial magnetization does not necessarily mean the completely opposite direction to the direction of the initial magnetization but may involve an angular difference of within ±15° from the completely opposite direction.

### <<Another Perpendicular Magnetic Field>>

The strength of the other perpendicular magnetic field is preferably less than 1.2 times the strength of the reversal magnetic field Hns of the perpendicular magnetic recording medium.

When the strength of the other perpendicular magnetic field is greater than or equal to 1.2 times the strength of the reversal magnetic field Hns of the perpendicular magnetic recording medium, the amplitude of the transfer signal formed on the perpendicular magnetic recording medium may greatly decrease.

The reversal magnetic field of the perpendicular magnetic recording medium is measured in accordance with the following method.

### <<<Method of Measuring Strength of Reversal Magnetic Field of Perpendicular Magnetic Recording Medium>>>

The reversal magnetic field of the perpendicular magnetic recording medium can be measured using a known Kerr effect measuring device. Specifically, when a Kerr rotation angle is measured while applying a magnetic field, such a Kerr loop as shown in FIG. 18 can be obtained, and the reversal magnetic field Hns can be measured as shown in FIG. 18.

Also, the strength of the other perpendicular magnetic field is preferably greater than or equal to 0.02 times, more preferably greater than or equal to 0.10 times, even more preferably greater than or equal to 0.15 times, the strength of the saturation magnetic field Hs of the magnetic layer of the master carrier.

When the strength of the other perpendicular magnetic field is less than 0.02 times the strength of the saturation magnetic field Hs of the magnetic layer of the master carrier, it may be impossible to adequately reduce the number of lost parts of a signal.

The strength of the saturation magnetic field Hs of the magnetic layer of the master carrier is measured in accordance with the following method.

### <<<Method of Measuring Saturation Magnetic Field Hs of Magnetic Layer of Master Carrier>>>

The saturation magnetic field Hs of the magnetic layer of the master carrier is calculated from a magnetization curve obtained using a known vibrating sample magnetometer, as shown in FIG. 17.

### <Other Step(s)>

The other step(s) is/are not particularly limited and may be suitably selected according to the purpose.

In carrying out the present invention, the protrusion pattern formed on the master disk 20 may be a negative pattern, as opposed to the positive pattern explained with FIG. 6J. In this case, a similar magnetization pattern can be magnetically transferred to the magnetic layer 16 of the slave disk 10 by reversing the direction of the initializing magnetic field Hi and the direction of the recording magnetic field Hd. Also, although a case where the magnetic field applying unit is an electromagnet has been explained in the present embodiment, a permanent magnet which similarly generates a magnetic field may be used as well.

### (Magnetic Recording Medium)

A magnetic recording medium of the present invention is not particularly limited as long as it is a magnetic recording medium to which magnetic information is transferred by the magnetic transfer method of the present invention, and the magnetic recording medium may be suitably selected according to the purpose.

A magnetic recording medium to which magnetic information has been transferred by the magnetic transfer method of the present invention will be used, installed in a magnetic recording and reproducing device such as a hard disk device, for example. This makes it possible to obtain a high-recording-density magnetic recording and reproducing device with high servo precision and excellent recording and reproducing properties.

### EXAMPLES

The following explains Examples of the present invention. It should, however, be noted that the present invention is not confined to these Examples in any way.

### Example 1

### Production of Master Carrier

An electron beam resist was applied onto an 8 inch Si (silicon) wafer (substrate) by spin coating so as to have a thickness of 100 nm. After the application, the resist on the substrate was exposed using a rotary electron beam exposure apparatus, then the exposed resist was developed, and a resist Si substrate having a concavo-convex pattern was thus produced.

Thereafter, the substrate was subjected to reactive ion etching, with the resist used as a mask, such that concave portions of the concavo-convex pattern enlarged downward. After this etching, the resist remaining on the substrate was removed by washing with a solvent capable of dissolving the resist. After the removal, the substrate was dried, and the dried substrate was used as an original master for producing a master carrier.

### <Production of Master Carrier Intermediate Member by Plating>

A Ni (nickel) conductive film was formed on the original master by sputtering so as to have a thickness of 20 nm. The original master on which the conductive film had been formed was immersed in a nickel sulfamate bath, and a Ni film having a thickness of 200 μm was formed by electrolytic plating. Thereafter, the Ni film was separated from the original master, which was followed by washing, and a Ni master carrier intermediate member was thus obtained.

### <Method of Forming Magnetic Layer for Magnetic Transfer>

An underlying layer made of a Ta film was formed on the master carrier intermediate member by sputtering so as to have a thickness of 10 nm. Sputtering conditions were as follows.

### <<Ta Film>>

Target material: Ta

Distance between target and base material: 200 mm

Argon pressure: 0.5 Pa

Electric power: 350 W DC

Thereafter, a magnetic layer (Co: 80 at. %, Pt: 20 at. %) was formed by sputtering so as to have a thickness of 30 nm, and a master carrier was thus obtained. Sputtering conditions for the magnetic layer were as follows.

Target material: Co80Pt20

Distance between target and base material: 200 mm

Argon pressure: 0.1 Pa

Electric power: 1,000 W DC

The saturation magnetic field Hs of the magnetic layer (perpendicular magnetization film) of the master carrier thus produced was 5 kOe.

The saturation magnetic field Hs of the magnetic layer of the master carrier was measured by the following method.

### <<<Method of Measuring Saturation Magnetic Field Hs of Magnetic Layer of Master Carrier>>>

The saturation magnetic field Hs of the magnetic layer of the master carrier was calculated from a magnetization curve obtained using a known vibrating sample magnetometer, as shown in FIG. 17.

On the master carrier produced in Example 1, there were space portions (concave portions) and line portions (convex portions) alternately formed to constitute a concavo-convex pattern to be transferred, in which the length of one period of concave and convex portions was 200 nm.

Here, the length of one period of concave and convex portions was measured in the following manner.

### <<<Method of Measuring Length of One Period of Concave and Convex Portions>>>

The length of one period of concave and convex portions was measured using a known scanning electron microscope (SEM) for length measurement. Specifically, the surface of the master carrier was observed using the SEM, and one period was defined as the distance from the edge situated between a concave portion and a convex portion to the edge situated between the next concave portion and the next convex portion.

### <Production of Perpendicular Magnetic Recording Medium>

A soft magnetic layer, a first nonmagnetic orientation layer, a second nonmagnetic orientation layer, a magnetic recording layer and a protective layer were formed, in this order, over a 2.5 inch glass substrate by sputtering. Further, a lubricant layer was formed on the protective layer by dipping. CoZrNb was used as the material for the soft magnetic layer. The soft magnetic layer had a thickness of 100 nm. The glass substrate was placed facing the CoZrNb target, then Ar gas was introduced such that the pressure stood at 0.6 Pa, and the soft magnetic layer was deposited at 1,500 W DC.

A 5 nm layer of Ti was formed as the first nonmagnetic orientation layer, and a 6 nm layer of Ru was formed as the second nonmagnetic orientation layer.

Specifically, the glass substrate and the soft magnetic layer were placed facing a Ti target, then Ar gas was introduced such that the pressure stood at 0.5 Pa, electric discharge was performed at 1,000 W DC, and a Ti seed layer was deposited as the first nonmagnetic orientation layer so as to have a thickness of 5 nm. Afterward, the glass substrate, the soft magnetic layer and the first nonmagnetic orientation layer were placed facing a Ru target, then Ar gas was introduced such that the pressure stood at 0.8 Pa, electric discharge was performed at 900 W DC, and the second nonmagnetic orientation layer was deposited so as to have a thickness of 6 nm.

Subsequently, a 18 nm layer of CoCrPtO was formed as the magnetic recording layer. Specifically, the glass substrate, the soft magnetic layer, the first nonmagnetic orientation layer and the second nonmagnetic orientation layer were placed facing a CoCrPtO target, then Ar gas containing 0.06% of O₂ was introduced such that the pressure stood at 14 Pa, electric discharge was performed at 290 W DC, and the magnetic recording layer was formed so as to have a thickness of 18 nm.

Afterward, the glass substrate and the above-mentioned layers were placed facing a C (carbon) target, then Ar gas was introduced such that the pressure stood at 0.5 Pa, electric discharge was performed at 1,000 W DC, and a carbon protective layer was formed so as to have a thickness of 4 nm. The coercive force Hc of this recording medium was adjusted to 334 kA/m (4.2 kOe), and the reversal magnetic field Hns was adjusted to 1.25 kOe.

Further, a PFPE lubricant was applied over the medium by dipping so as to have a thickness of 2 nm.

As described above, a perpendicular magnetic recording medium was produced.

The reversal magnetic field Hns of the perpendicular magnetic recording medium was measured in accordance with the following method.

### <<<Method of Measuring Reversal Magnetic Field Hns of Perpendicular Magnetic Recording Medium>>>

The reversal magnetic field Hns of the perpendicular magnetic recording medium could be measured using a known Kerr effect measuring device. Specifically, when a Kerr rotation angle was measured while applying a magnetic field, such a Kerr loop as shown in FIG. 18 could be obtained, and the reversal magnetic field was measured as shown in FIG. 18.

### <Initially Magnetizing Step>

The perpendicular magnetic recording medium was initially magnetized. The strength of the magnetic field applied at the time of the initial magnetization (initial magnetic field strength) was 10 kOe.

### <Closely Attaching Step and Magnetic Transfer Step>

The master carrier was placed facing the initially magnetized perpendicular magnetic recording medium, and these were closely attached to each other at a pressure of 0.7 MPa. With these closely attached to each other, a magnetic field was applied so as to perform magnetic transfer. The strength of the magnetic field used for the magnetic transfer was 4.6 kOe.

### <Separating Step>

After the magnetic field had finished being applied, the master carrier was separated from the perpendicular magnetic recording medium while applying a perpendicular magnetic field which acted in the opposite direction to the direction of the magnetic field applied at the time of the initial magnetization (which acted in the same direction as the direction of the magnetic field applied at the time of the magnetic transfer). The magnetic field strength at the time of the separating step was 100 Oe.

### <Evaluation>

The wavelength of a reproduction signal transferred, using the pattern of the master carrier, to the perpendicular magnetic recording medium having undergone the initially magnetizing step, the closely attaching step, the magnetic transfer step and the separating step was detected. For the detection, an evaluating device (LS-90, manufactured by Kyodo electronics inc.) with a GMR head having a read width of 120 nm and a write width of 200 nm was used.

### <<Evaluation of Number of Lost Parts of Signal on Magnetic Transfer Side>>

The number of lost parts of a signal on the magnetic transfer side was evaluated with respect to a signal having a length equivalent to that of 120 periods of concave and convex portions. As for evaluation criteria, loss of a part of the signal at a strength equivalent to 25% or less of the O-p distance (distance between 0V (0%) and the peak (100%)) (signal peak on the magnetic transfer side) is denoted by V 25% (as shown by “a” in FIG. 12), loss of a part of the signal at a strength equivalent to 50% or less of the O-p distance is denoted by V 50% (as shown by “b” in FIG. 12), and loss of a part of the signal at a strength equivalent to 75% or less of the O-p distance is denoted by V 75% (as shown by “c” in FIG. 12).

Also, the number of lost parts of the signal was judged as follows: when the number of times V 50% occurred was more than five, it was judged to be “D”; when the number of times V 50% occurred was five or less, it was judged to be “C”; when the number of times V 50% occurred was two or less, it was judged to be “B”; and when the number of times V 50% occurred was one or less, it was judged to be “A”.

The results of the evaluation are shown in Table 1.

### <<Evaluation of Amplitude of Transfer Signal>>

The amplitude of a transfer signal was defined as the p-p distance (distance between the peaks) of the signal. The p-p distance concerning Example 1 (Comparative Example 1) was assumed to be 1, and the ratios of the p-p distances concerning Examples 2 to 7 and Comparative Example 2 to this p-p distance concerning Example 1 (Comparative Example 1) are shown in Table 1.

Also, the amplitude of the transfer signal was judged as follows: when the ratio was more than 0.8, it was judged to be “A”; when the ratio was 0.8 or less, it was judged to be “B”.

### Example 2

A master carrier and a perpendicular magnetic recording medium were produced, an initially magnetizing step, a closely attaching step, a magnetic transfer step and a separating step were performed and evaluations were carried out in the same manner as in Example 1, except that the magnetic field strength at the time of the separating step was changed from 100 Oe to 250 Oe. The results are shown in Table 1.

### Example 3

A master carrier and a perpendicular magnetic recording medium were produced, an initially magnetizing step, a closely attaching step, a magnetic transfer step and a separating step were performed and evaluations were carried out in the same manner as in Example 1, except that the magnetic field strength at the time of the separating step was changed from 100 Oe to 500 Oe. The results are shown in Table 1.

### Example 4

A master carrier and a perpendicular magnetic recording medium were produced, an initially magnetizing step, a closely attaching step, a magnetic transfer step and a separating step were performed and evaluations were carried out in the same manner as in Example 1, except that the magnetic field strength at the time of the separating step was changed from 100 Oe to 750 Oe. The results are shown in Table 1.

### Example 5

A master carrier and a perpendicular magnetic recording medium were produced, an initially magnetizing step, a closely attaching step, a magnetic transfer step and a separating step were performed and evaluations were carried out in the same manner as in Example 1, except that the magnetic field strength at the time of the separating step was changed from 100 Oe to 1,000 Oe. The results are shown in Table 1.

### Example 6

A master carrier and a perpendicular magnetic recording medium were produced, an initially magnetizing step, a closely attaching step, a magnetic transfer step and a separating step were performed and evaluations were carried out in the same manner as in Example 1, except that the magnetic field strength at the time of the separating step was changed from 100 Oe to 1,500 Oe. The results are shown in Table 1.

### Example 7

A master carrier and a perpendicular magnetic recording medium were produced, an initially magnetizing step, a closely attaching step, a magnetic transfer step and a separating step were performed and evaluations were carried out in the same manner as in Example 1, except that the magnetic field strength at the time of the separating step was changed from 100 Oe to 2,000 Oe. The results are shown in Table 1.

### Comparative Example 1

A master carrier and a perpendicular magnetic recording medium were produced, an initially magnetizing step, a closely attaching step, a magnetic transfer step and a separating step were performed and evaluations were carried out in the same manner as in Example 1, except that the magnetic field strength at the time of the separating step was changed from 100 Oe to 0 Oe. The results are shown in Table 1.

### Comparative Example 2

A master carrier and a perpendicular magnetic recording medium were produced, an initially magnetizing step, a closely attaching step, a magnetic transfer step and a separating step were performed and evaluations were carried out in the same manner as in Example 1, except that the magnetic field strength at the time of the separating step was changed from 100 Oe to 0 Oe and that a magnetic field having a strength of 1,500 Oe was applied only to the perpendicular magnetic recording medium after separated from the master carrier. The results are shown in Table 1.

TABLE 1

| | | Strength | | | | | | | |
|---|---|---|---|---|---|---|---|---|---|
| | | of | | | | | | | |
| | | magnetic | | | | | | | |
| | | field | | | | | | | |
| | Magnetic | applied to | | | | | | | |
| | field | medium | | | | | | | |
| | strength | after | | | | | | | |
| | at the time | separated | | | | Evaluation | | Evaluation | |
| | of | from | Number of lost parts of | | | of number | | of | |
| | separating | master | signal on magnetic | | | of lost | Amplitude | amplitude | |
| | step | carrier | transfer side | | | parts of | of transfer | of transfer | Overall |
| | (Oe) | (Oe) | V 25% | V 50% | V 75% | signal | signal | signal | evaluation |
| Ex. 1 | 100 | 0 | 2 | 5 | 15 | C | 1.00 | A | C |
| Ex. 2 | 250 | 0 | 1 | 3 | 11 | C | 1.02 | A | C |
| Ex. 3 | 500 | 0 | 1 | 2 | 7 | B | 1.00 | A | B |
| Ex. 4 | 750 | 0 | 0 | 1 | 6 | A | 0.93 | A | A |
| Ex. 5 | 1,000 | 0 | 0 | 0 | 3 | A | 0.98 | A | A |
| Ex. 6 | 1,500 | 0 | 0 | 0 | 0 | A | 0.68 | B | B |
| Ex. 7 | 2,000 | 0 | 0 | 0 | 1 | A | 0.63 | B | B |
| Comp | 0 | 0 | 2 | 7 | 18 | D | 1.00 | A | D |
| Ex. 1 | | | | | | | | | |
| Comp | 0 | 1,500 | 3 | 11 | 15 | D | 0.75 | B | D |
| Ex. 2 | | | | | | | | | |

Table 1 demonstrates that it was possible to reduce the number of lost parts of a signal on the magnetic transfer side by applying a magnetic field at the time of the separating step (Examples 1 to 7), and that the greater the strength of the magnetic field applied at the time of the separating step was, the more reduced the number of lost parts of the signal on the magnetic transfer side could be. Here, when the saturation magnetic field of the magnetic layer (perpendicular magnetization film) of the master carrier is assumed to be Hs (5 kOe), the strength of the magnetic field applied at the time of the separating step is preferably 0.02 Hs (100 Oe as in Example 1) or greater, more preferably 0.1 Hs (500 Oe as in Example 3) or greater, and even more preferably 0.15 Hs (750 Oe as in Example 4) or greater.

Table 1 also demonstrates that when the strength of the magnetic field applied in the separating step was 1,500 Oe or greater (as in Examples 6 and 7), the amplitude of a transfer signal decreased, and that also when a magnetic field having a strength of 1,500 Oe was applied only to the perpendicular magnetic recording medium after the signal transfer (as in Comparative Example 2), the amplitude of a transfer signal decreased. These results show that the strength of the magnetic field applied in the separating step is preferably less than 1.2 times (1,500 Oe) the strength of the reversal magnetic field Ens (1.25 kOe) of the perpendicular magnetic recording medium.

Specifically, it is desirable that the strength of the magnetic field applied in the separating step be 0.15 Hs (750 Oe) or greater, and less than 1.2 times (1,500 Oe) the strength of the reversal magnetic field Ens (1.25 kOe) of the perpendicular magnetic recording medium (as in Examples 4 and 5).

As to these phenomena, it is inferred that the signal amplitude decreased because the magnetization on the initially magnetized side (portions corresponding to the concave portions of the master carrier) in the magnetic pattern formed by the magnetic transfer was reversed and thus the signal level on the initially magnetized side came close to the signal level on the magnetic transfer side regarding a transfer signal formed on the perpendicular magnetic recording medium. Specifically, it is inferred that since an external magnetic field was uniformly applied to the perpendicular magnetic recording medium the moment the master carrier was separated from the perpendicular magnetic recording medium, the magnetization on the initially magnetized side (portions corresponding to the concave portions of the master carrier) was reversed when the external magnetic field had great strength.

### Example 8

A master carrier was produced in the same manner as in Example 1, except that a master carrier having a pattern in which concave portions and convex portions were alternately formed and the length of one period of concave and convex portions was 120 nm was used, and that an FesoCo₂₀ film (Fe: 80 at. %, Co: 20 at. %) having a thickness of 40 nm was formed as a magnetic layer for magnetic transfer.

Also, a perpendicular magnetic recording medium was produced, an initially magnetizing step, a closely attaching step, a magnetic transfer step and a separating step were performed and evaluations were carried out in the same manner as in Example 1, except that the magnetic field strength at the time of the separating step was changed to 750 Oe. The results are shown in Table 2.

### Comparative Example 3

A master carrier and a perpendicular magnetic recording medium were produced, an initially magnetizing step, a closely attaching step, a magnetic transfer step and a separating step were performed and evaluations were carried out in the same manner as in Example 8, except that the magnetic field strength at the time of the separating step was changed from 750 Oe to 0 Oe. The results are shown in Table 2.

TABLE 2

| | Magnetic | | | | | | | |
|---|---|---|---|---|---|---|---|---|
| | field | | | | | | | |
| | strength | | | | | | | |
| | at the time | | | | Evaluation | | Evaluation | |
| | of | Number of lost parts of | | | of number | | of | |
| | separating | signal on magnetic | | | of lost | Amplitude | amplitude | |
| | step | transfer side | | | parts of | of transfer | of transfer | Overall |
| | (Oe) | V 25% | V 50% | V 75% | signal | signal | signal | evaluation |
| Ex. 8 | 750 | 1 | 4 | 13 | C | 1.00 | A | C |
| Comp | 0 | 2 | 6 | 15 | D | 0.93 | A | D |
| Ex. 3 | | | | | | | | |

It was found that also in the case where the Fe₈₀Co₂₀ film, a non-oriented film, was used as a magnetic layer of the master carrier, the number of lost parts of a signal on the magnetic transfer side could be reduced by applying a magnetic field at the time of the separating step.

What is claimed is:

1. A magnetic transfer method comprising:
initially magnetizing a perpendicular magnetic recording medium in a perpendicular direction;
closely attaching a magnetic transfer master carrier to the initially magnetized perpendicular magnetic recording medium;
transferring magnetic information to the perpendicular magnetic recording medium by applying a perpendicular magnetic field which acts in the opposite direction to the direction of the initial magnetization, with the perpendicular magnetic recording medium and the magnetic transfer master carrier closely attached to each other; and
separating the magnetic transfer master carrier, which is closely attached to the perpendicular magnetic recording medium, from the perpendicular magnetic recording medium,
wherein in the separating, the magnetic transfer master carrier is separated from the perpendicular magnetic recording medium while applying another perpendicular magnetic field which acts in the opposite direction to the direction of the initial magnetization.

2. The magnetic transfer method according to claim 1, wherein the magnetic transfer master carrier is provided with a magnetic layer, and the magnetic layer has perpendicular magnetic anisotropy.

3. The magnetic transfer method according to claim 1, wherein the strength of the another perpendicular magnetic field is less than 1.2 times the strength of a reversal magnetic field of the perpendicular magnetic recording medium.

4. The magnetic transfer method according to claim 2, wherein the strength of the another perpendicular magnetic field is greater than or equal to 0.02 times the strength of a saturation magnetic field of the magnetic layer.

5. The magnetic transfer method according to claim 4, wherein the strength of the another perpendicular magnetic field is greater than or equal to 0.10 times the strength of the saturation magnetic field of the magnetic layer.

6. The magnetic transfer method according to claim 5, wherein the strength of the another perpendicular magnetic field is greater than or equal to 0.15 times the strength of the saturation magnetic field of the magnetic layer.

7. A magnetic recording medium to which magnetic information has been transferred by a magnetic transfer method which comprises:
initially magnetizing a perpendicular magnetic recording medium in a perpendicular direction;
closely attaching a magnetic transfer master carrier to the initially magnetized perpendicular magnetic recording medium;
transferring magnetic information to the perpendicular magnetic recording medium by applying a perpendicular magnetic field which acts in the opposite direction to the direction of the initial magnetization, with the perpendicular magnetic recording medium and the magnetic transfer master carrier closely attached to each other; and
separating the magnetic transfer master carrier, which is closely attached to the perpendicular magnetic recording medium, from the perpendicular magnetic recording medium,
wherein in the separating, the magnetic transfer master carrier is separated from the perpendicular magnetic recording medium while applying another perpendicular magnetic field which acts in the opposite direction to the direction of the initial magnetization.
